(19) United States
(12) Patent Application Publication
(10) Pub. No.: US 2022/0250295 A1
(43) Pub. Date: Aug. 11, 2022

(54) OVERMOULDING A PROFILE FOR PRODUCING A SHAPED ARTICLE, A SHAPED ARTICLE OBTAINED THEREFROM AND USE THEREOF

(71) Applicant: BASF SE, Ludwigshafen am Rhein (DE)

(72) Inventors: Kipp Grumm, Wyandotte, MI (US); Elias Ruda Shakour, Wyandotte, MI (US)

(21) Appl. No.: 17/624,238

(22) PCT Filed: Jun. 23, 2020
(86) PCT No.: PCT/EP2020/067466

§ 371 Date: Dec. 30, 2021

Related U.S. Application Data
(60) Provisional application No. 62/869,187, filed on Jul. 1, 2019.

(30) Foreign Application Priority Data
Aug. 1, 2019 (EP) 19189509.3

(51) Int. Cl. B29C 45/14; B29C 69/02; B29C 70/52; B29C 48/00; B29C 48/12

(52) U.S. Cl. CPC B29C 45/14311; B29C 69/02; B29C 45/14786; B29K 2101/12; B29C 48/001; B29C 48/12; B29C 2045/14327; B29C 70/52

(57) ABSTRACT

The present invention relates to a method for producing a shaped article, a shaped article obtained therefrom and the use of the shaped article in vehicle door intrusion beams, structural inserts in body in white, bumper beams, instrument panel cross members, seating structural inserts and front-end module structures.

### FIELD OF INVENTION

The present invention relates to a method for producing a shaped article, a shaped article obtained therefrom and the use of the shaped article in vehicle door intrusion beam, structural inserts in body in white, bumper beams, instrument panel cross members, seating structural inserts and front-end module structures.

### BACKGROUND OF THE INVENTION

Pultrusion and extrusion have been extensively used for manufacturing continuous, constant cross-section composite profiles. These techniques, when employed using engineering polymers, provide for a profile which is inexpensive, has high strength and stiffness due to high continuous or discontinuous fiber material. However, the profile is limited in geometry. That is, to say, that the profile geometry has a continuous cross-section.

Automotives make extensive use of engineering polymers, particularly the pultruded or extruded profiles made therefrom. These profiles find application in areas such as, but not limited to, structural inserts in body in white (BIW), vehicle door intrusion beam, bumper beams, instrument panel cross members, seating structural inserts and front-end module structure.

US 2015/129116 A1 describes a method of manufacturing a crash-resistant structural part for an automobile, the crash-resistant structural part including a beam element for receiving an impact force during crash of the automobile. The structural part is entirely derived from thermoplastics, with overmolding being used for joining these thermoplastic materials.

U.S. Pat. No. 6,844,040 B2 discloses reinforced composite structural members which have sufficient strength and stiffness to be used in place of wooden members. The structural members are entirely made from thermoplastics (e.g. thermoplastic resin cellulosic fibers). Dove tail like surface features are described, but in the context of combining thermoplastic materials only.

Despite their advantages, these pultruded or extruded profiles having continuous cross-section, do not allow for complete utilization of the capabilities of the engineering polymers. In other words, the superior mechanical properties of the engineering polymers remain unutilized, when continuous pultruded or extruded profiles are manufactured.

Often, these profiles are required to undergo further processing to render them suitable for application in automotives. This, however, adds on to the final cost of these profiles, thereby rendering them expensive. Also, while obtaining a complex profile geometry from these pultruded or extruded profiles, the additional manufacturing steps compulsorily involve the use of adhesives or fastening means. The use of adhesives and fastening means further add to the cost of these profiles.

Additionally, as noted above, the state of the art is also silent about combining a thermoplastic material with a thermoset material, and still result in acceptable mechanical properties.

It was, therefore, an object of the presently claimed invention to provide a method for producing a shaped article, whereby the shaped article thus obtained has a thermoplastic material injection molded to a pultruded thermoset material, which provides for a complex geometry having acceptable or in fact good mechanical properties and is relatively inexpensive to manufacture.

### SUMMARY OF THE INVENTION

Surprisingly, it has been found that the above object is met by providing a method for producing a shaped article (100), whereby the shaped article thus obtained is formed by a positive lock between a first element (10) obtained by pultrusion or extrusion and a second element (20) obtained by injection molding, as described hereinbelow.

Accordingly, in one aspect, the presently claimed invention is directed to a method for producing a shaped article (100), said method comprising at least the steps of:
(A) pultruding or extruding a fiber reinforced polyurethane in a die to obtain a first element (10), said die comprising a plurality of first surface features,
   wherein the first element (10) comprises an outer surface (11), said outer surface (11) comprising a plurality of second surface features (12) formed by the plurality of first surface features in the die,
(B) injection molding a second element (20) onto the first element (10) to obtain the shaped article (100), wherein the second element (20) comprises an outer surface (21), said outer surface (21) comprising a plurality of third surface features (22),
wherein the first element (10) positively locks the second element (20) such that each of the second surface features (12) completely overlap with each of the third surface features (22).

In another aspect, the presently claimed invention is directed to a shaped article (100) obtained above.

In yet another aspect, the presently claimed invention is directed to the use of the above shaped article (100) in vehicle door intrusion beams, structural inserts in body in white, bumper beams, instrument panel cross members, seating structural inserts and front-end module structures.

### BRIEF DESCRIPTION OF THE FIGURES

FIG. 1 illustrates a perspective representation of a first element (10) according to the present invention.

FIG. 2A illustrates a first embodiment of second surface feature (12) of the first element (10).

FIG. 2B illustrates a second embodiment of second surface feature (12) of the first element (10).

FIG. 2C illustrates a third embodiment of second surface feature (12) of the first element (10).

FIG. 2D illustrates a fourth embodiment of second surface feature (12) of the first element (10).

FIG. 3 illustrates another perspective representation of the first element (10) according to the present invention.

FIG. 4 illustrates a shaped article (100) according to the present invention.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

An aspect of the present invention is embodiment 1, directed to a method for producing a shaped article (100), said method comprising at least the steps of:
(A) pultruding or extruding a fiber reinforced polyurethane in a die to obtain a first element (10), said die comprising a plurality of first surface features,
   wherein the first element (10) comprises an outer surface (11), said outer surface (11) comprising a plurality of second surface features (12) formed by the plurality of first surface features in the die,
(B) injection molding a second element (20) onto the first element (10) to obtain the shaped article (100), wherein the second element (20) comprises an outer surface (21), said outer surface (21) comprising a plurality of third surface features (22),
   wherein the first element (10) positively locks the second element (20) such that each of the second surface features (12) completely overlap with each of the third surface features (22).

### Fiber Reinforced Polyurethane

In an embodiment, the fiber reinforced polyurethane in the embodiment 1 comprises a fiber material and a polyurethane resin.

In one embodiment, the fiber material has an area weight in between 100 g/m² to 1500 g/m². Suitable fiber material for the fiber reinforced polyurethane in the embodiment 1 is selected from metal fiber, metalized inorganic fiber, metalized synthetic fiber, glass fiber, polyester fiber, polyamide fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.

In other embodiment, the fiber material is selected from metal fiber, metalized inorganic fiber, metalized synthetic fiber, glass fiber, polyester fiber, polyamide fiber, graphite fiber, carbon fiber and ceramic fiber. In yet other embodiment, the fiber material is selected from glass fiber, carbon fiber, polyester fiber, polyamide fiber, aramid fiber and basalt fiber. In still other embodiment, the fiber material is selected from glass fiber and carbon fiber.

In one embodiment, the fiber material comprises glass fiber. Suitable glass fibers are well known to the person skilled in the art. For example, chopped glass fibers and continuous glass fibers can be used for this purpose.

In another embodiment, the fiber material comprises chopped glass fibers. The chopped glass fibers can be obtained in any shape and size. For instance, the chopped glass fibers can be, such as, but not limited to, multiple strands or rovings of glass fiber having a lateral and through-plane dimension or a spherical particle having diameter. The present invention is not limited by shape and size of the chopped glass fibers. A person skilled in the art is aware of these selections and modifications. However, in an embodiment, the chopped glass fibers can have a length in between 10 mm to 150 mm.

Any suitable binding agent can be used for binding the chopped glass fibers. In one embodiment, the binding agent comprises an acrylic binder. The acrylic binder is a cured aqueous based acrylic resin. The binder cures, for instance, through linkage of carboxylic groups and hydroxyl groups of multi-functional alcohols.

Acrylic binders are polymers or copolymers containing units of acrylic acid, methacrylic acid, their esters or related derivatives. The acrylic binders are for instance formed by aqueous emulsion polymerization employing (meth)acrylic acid (where the convention (meth)acrylic is intended to embrace both acrylic and methacrylic), 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, octadecyl(meth)acrylate, stearyl(meth)acrylate, tetrahydrofurfuryl(meth)acrylate, butoxyethyl(meth)acrylate, ethoxydiethylene glycol (meth)acrylate, benzyl(meth)acrylate, cyclohexyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethoxyethyl(meth)acrylate, methoxypolyethylene glycol (meth)acrylate, methoxypolypropylene glycol (meth)acrylate, dicyclopentadiene(meth)acrylate, dicyclopentanyl(meth)acrylate, tricyclodecanyl(meth)acrylate, isobornyl(meth)acrylate, bornyl(meth)acrylate or mixtures thereof.

Other monomers which can be co-polymerized with the (meth)acrylic monomers, generally in a minor amount, include styrene, diacetone(meth)acrylamide, isobutoxymethyl(meth)acrylamide, N-vinylpyrrolidone, N-vinylcaprolactam, N,N-dimethyl(meth)acrylamide, t-octyl(meth)acrylamide, N,N-diethyl(meth)acrylamide, N,N′-dimethyl-aminopropyl(meth)acrylamide, (meth)acryloylmorphorine; vinyl ethers such as hydroxybutyl vinyl ether, lauryl vinyl ether, cetyl vinyl ether, and 2-ethylhexyl vinyl ether; maleic acid esters; fumaric acid esters and similar compounds.

Multi-functional alcohols are for instance hydroquinone, 4,4′-dihydroxydiphenyl, 2,2-bis(4-hydroxyphenyl)propane, cresols or alkylene polyols containing 2 to 12 carbon atoms, including ethylene glycol, 1,2- or 1,3-propanediol, 1,2-, 1,3- or 1,4-butanediol, pentanediol, hexanediol, octanediol, dodecanediol, diethylene glycol, triethylene glycol, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol, tripentaerythritol and sorbitol.

In another embodiment, if the fiber material comprises continuous glass fibers, use of the binding agents, as described hereinabove, can be avoided. The present invention is not limited by the choice of the shape and size of the continuous glass fibers as the person skilled in the art is aware of the same. The continuous glass fibers can be oriented in one direction or in several directions, for instance, lateral, perpendicular or any angle between lateral and perpendicular. The fiber mat layer comprising continuous glass fibers has the area weight between 100 g/m² to 1000 g/m².

In another embodiment, the fiber material can be a hybrid layer comprising at least one layer of chopped glass fibers and at least one layer of continuous glass fibers. Moreover, it can also comprise a thin film or scrim to enhance its surface quality. The said thin film or scrim can be inserted on top of the hybrid layer.

In an embodiment, a single layer of fiber material can be employed for obtaining the fiber reinforced polyurethane in the embodiment 1. Alternatively, multiple layers of fiber materials with each layer being the same or different can also be used for obtaining the fiber reinforced polyurethane in the embodiment 1.

In another embodiment, the fiber material can have any suitable shape and size. Accordingly, the fiber material can be selected from a strand, braided strands, woven or non-woven mat structures, bundles and combinations thereof. For instance, the fiber material can have a length in between 50 mm to 150 mm and a diameter in between 1 μm to 50 μm.

In one embodiment, the fiber material can be subjected to a surface treatment agent. The surface treatment agent is referred to as sizing. Suitable sizings are well known to the person skilled in the art. In one embodiment, the surface treatment agent is a coupling agent and is selected from a silane coupling agent, a titanium coupling agent and an aluminate coupling agent. Any suitable techniques for surface treatment can be used for this purpose. For instance, dip coating and spray coating can be employed.

In an embodiment, the fiber material is subjected to the surface treatment using a silane coupling agent. Suitable silane coupling agents are selected from aminosilane, epoxysilane, methyltrimethoxysilane, methyltriethoxysilane, γ-glycidoxypropyltrimethoxysilane, vinyltriacetoxysilane and vinyltrimethoxysilane. In another embodiment, the silane coupling agent comprises epoxysilane or aminosilane.

In one embodiment, the fiber material comprises glass fiber which is subjected to a silane coupling agent.

Suitable amounts of fiber material are well known to a person skilled in the art. However, in one embodiment, the fiber material can be present in an amount in between 10 wt.-% to 60 wt.-%, based on the total weight of the fiber reinforced polyurethane.

In another embodiment, the polyurethane resin is obtained by reacting:
(a) an isocyanate, and
(b) a compound reactive towards isocyanate.

In one embodiment, the polyurethane resin is a thermoset material. Said otherwise, the polyurethane resin has a crosslinked structure.

Suitable isocyanates for the present invention have an average functionality of at least 2.0; or in between 2.0 to 3.0. These isocyanates comprise aliphatic isocyanates or aromatic isocyanates. It is to be understood that the isocyanate includes both monomeric and polymeric forms of the aliphatic and aromatic isocyanate. By the term “polymeric”, it is referred to the polymeric grade of the aliphatic and/or aromatic isocyanate comprising, independently of each other, different oligomers and homologues. In one embodiment, the aromatic isocyanate is used for obtaining the polyurethane resin as described herein.

In one embodiment, the isocyanate has a free isocyanate group content (NCO content) in the range of 5 wt. % to 50 wt. %, or in between 8 wt. % to 40 wt. %, or in between 9 wt. % to 35 wt. %.

In an embodiment, the aliphatic isocyanate is selected from tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocyanatomethylcyclohexane isocyanates, isocyanatoethylcyclohexane isocyanates, bis(isocyanatomethyl)-cyclohexane diisocyanates, 4,4′-diisocyanatodicyclohexylmethane, pentamethylene 1,5-diisocyanate, isophorone diisocyanate and mixtures thereof.

In another embodiment, the aromatic isocyanate is selected from toluene diisocyanate; polymeric toluene diisocyanate, methylene diphenyl diisocyanate; polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-di isopropyl ben-zene-2,4,6-triisocyanate, tolidine diisocyanate, 1,3,5-triisopropyl benzene-2,4,6-triisocyanate and mixtures thereof.

In other embodiment, the aromatic isocyanates comprise toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate and 1-methyl-3,5-diethylphenylene-2,4-diisocyanate or a combination thereof. In yet other embodiment, the aromatic isocyanates comprise toluene diisocyanate; polymeric toluene diisocyanate, methylene diphenyl diisocyanate; polymeric methylene diphenyl diisocyanate, m-phenylene diisocyanate and 1,5-naphthalene diisocyanate or a combination thereof. In still other embodiment, the aromatic isocyanates comprise toluene diisocyanate; polymeric toluene diisocyanate, methylene diphenyl diisocyanate and polymeric methylene diphenyl diisocyanate or a combination thereof. In a further embodiment, the isocyanate comprises methylene diphenyl diisocyanate and/or polymeric methylene diphenyl diisocyanate.

Methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate can be classified into monomeric methylene diphenyl diisocyanate and polymeric methylene di-phenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2.0. The isomeric ratio as well as the amount of oligomeric species can vary in wide ranges in these products. For instance, polymeric methylene diphenyl diisocyanate may typically contain 30 wt.-% to 80 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

In another embodiment, the reaction products of polyisocyanates with polyhydric polyols and their mixtures with other diisocyanates and polyisocyanates can also be used.

In yet another embodiment, the isocyanate comprises modified isocyanates, for example, carbodiimide-modified isocyanates, urethane-modified isocyanates, allophanate-modified isocyanates, isocyanurate-modified isocyanates, urea-modified isocyanates and biuret-containing isocyanates.

In still another embodiment, the isocyanate comprises a carbodiimide-modified methylene diphenyl diisocyanate, as described hereinabove. The carbodiimide-modified isocyanates have a tri-functional uretonimine species within the remaining difunctional monomeric MDI and are liquids that are stable and clear at room temperature. By “monomeric MDI”, it is referred to pure 4,4′-MDI or a blend of 2,4′-MDI and 4,4′-MDI. Commercially available isocyanates available under the tradename, such as, but not limited to, Lupranat® from BASF can also be used for the purpose of the present invention.

Suitable amounts of isocyanates are such that the isocyanate index is in between 70 to 350, or in between 80 to 300, or in between 90 to 200, or in between 100 to 150. The isocyanate index of 100 corresponds to one isocyanate group per one isocyanate reactive group.

In another embodiment, compounds that are reactive towards isocyanate include compounds having a molecular weight of 400 g/mol or more and chain extenders having molecular weight in between 49 g/mol to 399 g/mol.

Suitable compounds being reactive towards isocyanate and having a molecular weight of 400 g/mol or more are compounds having hydroxyl groups, also referred to as polyol. Suitable polyols have an average functionality in between 2.0 to 8.0, or in between 2.0 to 6.5, or in between 2.5 to 6.5 and a hydroxyl number in between 15 mg KOH/g to 1800 mg KOH/g, or in between 15 mg KOH/g to 1500 mg KOH/g, or even between 100 mg KOH/g to 1500 mg KOH/g. The compounds that are reactive towards isocyanate can be present in an amount in between 1 wt.-% to 99 wt.-%, based on the total weight of the polyurethane resin.

In one embodiment, the polyol is selected from polyether polyols, polyester polyols, polyether-ester polyols or a mixture thereof.

Polyether polyols, according to the invention, have an average functionality in between 2.0 to 8.0, or in between 2.0 to 6.5, or in between 2.0 to 5.5, or in between 2.0 to 4.0, and a hydroxyl number in between 15 mg KOH/g to 1500 mg KOH/g, or in between 20 mg KOH/g to 1500 mg KOH/g, or even between 20 mg KOH/g to 1000 mg KOH/g, or in between 50 mg KOH/g to 400 mg KOH/g.

In another embodiment, the polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that their average functionality is in between 2.0 to 8.0, or in between 3.0 to 8.0. Optionally, a mixture of suitable starter molecules is used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia. In one embodiment, amine containing starter molecules comprise ethylenediamine, phenylenediamines, toluenediamine or isomers thereof. In other embodiment, the amine containing starter molecules comprise ethylenediamine.

Hydroxyl-containing starter molecules comprise sugars, sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

In one embodiment, the hydroxyl-containing starter molecules comprise sugar and sugar alcohols such as sucrose, sorbitol, glycerol, pentaerythritol, trimethylolpropane and mixtures thereof. In other embodiment, the hydroxyl-containing starter molecules comprise sucrose, glycerol, pentaerythritol and trimethylolpropane.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene oxides can be used singly, alternatingly in succession or as mixtures. In one embodiment, the alkylene oxides are propylene oxide and/or ethylene oxide. In other embodiment, the alkylene oxides are mixtures of ethylene oxide and propylene oxide that comprise more than 50 wt.-% of propylene oxide.

Suitable amounts of the polyether polyols are in between 1 wt.-% to 99 wt.-%, based on the total weight of the polyurethane resin, or in between 20 wt.-% to 99 wt.-%, or even in between 40 wt.-% to 99 wt.-%.

Suitable polyester polyols have an average functionality in between 2.0 to 6.0, or between 2.0 to 5.0, or between 2.0 to 4.0, and a hydroxyl number in between 30 mg KOH/g to 250 mg KOH/g, or between 100 mg KOH/g to 200 mg KOH/g.

Polyester polyols, according to the present invention, are based on the reaction product of carboxylic acids or anhydrides with hydroxyl group containing compounds. Suitable carboxylic acids or anhydrides have from 2 to 20 carbon atoms, or from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride. Particularly comprising phthalic acid, isophthalic acid, terephthalic acid, oleic acid and phthalic anhydride or a combination thereof.

Suitable hydroxyl containing compounds comprise ethanol, ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methylpropane-1,3-diol, glycerol, trimethylolpropane, hex-ane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylene-propylene glycol, dibutylene glycol and polybutylene glycol. Preferably, hydroxyl containing compounds comprise ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside and diethylene glycol or a combination thereof. In some embodiments, the hydroxyl containing compounds comprise ethylene glycol, propylene-1,2-glycol, propylene-1,3-glycol, butyl-ene-1,4-glycol, butylene-2,3-glycol, hexane-1,6-diol, octane-1,8-diol, neopentyl glycol and diethylene glycol or a combination thereof. In other embodiments, the hydroxyl containing compounds are selected from hexane-1,6-diol, neopentyl glycol and diethylene glycol or a combination thereof.

Suitable polyether-ester polyols have a hydroxyl number in between 100 mg KOH/g to 460 mg KOH/g, or between 150 mg KOH/g to 450 mg KOH/g, or even between 250 mg KOH/g to 430 mg KOH/g and in any of these embodiments may have an average functionality in between 2.3 to 5.0, or even between 3.5 to 4.7.

Such polyether-ester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

The starter molecules of component i) are generally selected such that the average functionality of component i) is in between 3.8 to 4.8, or from 4.0 to 4.7, or even from 4.2 to 4.6. Optionally, a mixture of suitable starter molecules is used.

In one embodiment, the hydroxyl-containing starter molecules of component i) are selected from sugars, sugar alcohols (glucose, mannitol, sucrose, pentaerythritol, sorbitol), polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

In other embodiment, the hydroxyl-containing starter molecules of component i) are selected from sugars and sugar alcohols such as sucrose and sorbitol, glycerol, and mixtures of said sugars and/or sugar alcohols with glycerol, water and/or glycols such as, for example, diethylene glycol and/or dipropylene glycol. In yet other embodiment, the component i) is selected from glycerol, diethylene glycol and dipropylene glycol. In another embodiment, the component i) comprises a mixture of sucrose and glycerol.

Said fatty acid or fatty acid monoester ii) is selected from polyhydroxy fatty acids, ricinoleic acid, hydroxyl-modified oils, hydroxyl-modified fatty acids and fatty acid esters based in myristoleic acid, palmitoleic acid, oleic acid, stearic acid, palmitic acid, vaccenic acid, petroselic acid, gadoleic acid, erucic acid, nervonic acid, linoleic acid, a- and g-linolenic acid, stearidonic acid, arachidonic acid, timnodonic acid, clupanodonic acid and cervonic acid or a combination thereof. The fatty acid methyl esters are the preferred fatty acid monoesters. In one embodiment, the fatty acids ii) are selected from stearic acid, palmitic acid, linolenic acid and especially oleic acid, monoesters thereof. In other embodiment, the fatty acids ii) comprise methyl esters and mixtures thereof. Fatty acids are used as purely fatty acids. In this regard, preference is given to using fatty acid methyl esters such as, for example, biodiesel or methyl oleate.

Biodiesel is to be understood as meaning fatty acid methyl esters within the meaning of the EN 14214 standard from 2010. Principal constituents of biodiesel, which is generally produced from rapeseed oil, soybean oil or palm oil, are methyl esters of saturated C₁₆ to C₁₈ fatty acids and methyl esters of mono- or polyunsaturated C₁₈ fatty acids such as oleic acid, linoleic acid and linolenic acid.

Suitable alkylene oxides iii) having 2 to 4 carbon atoms are, for example, ethylene oxide, propylene oxide, tetrahydrofuran, 1,2-butylene oxide, 2,3-butylene oxide and/or styrene oxide. Alkylene oxides can be used singly, alternatingly in succession or as mixtures.

In one embodiment, the alkylene oxides comprise propylene oxide and ethylene oxide. In other embodiment, the alkylene oxide is a mixture of ethylene oxide and propylene oxide comprising more than 50 wt.-% of propylene oxide. In another embodiment, the alkylene oxide comprises purely propylene oxide.

In another embodiment, suitable chain extenders are selected from alkanol amines, diols and/or triols having molecular weights in between 60 g/mol to 300 g/mol. Suitable amounts of these chain extenders are known to the person skilled in the art. For instance, the chain extenders can be present in an amount up to 99 wt.-%, or up to 20 wt.-%, based on the total weight of the polyurethane resin.

In yet another embodiment, commercially available compounds that are reactive towards isocyanate can also be employed, for e.g. Sovermol®, Pluracol® and Quadrol® from BASF.

In still another embodiment, the polyurethane resin as described herein can be obtained in the presence of catalysts and/or additives. Suitable catalysts are well known to the person skilled in the art. For instance, tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof can be used as catalysts.

In one embodiment, tertiary amines include, such as but not limited to, triethylamine, tributylamine, N-methylmorpholine, N-ethylmorpholine, N,N, N′,N′-tetramethylethylenediamine, pentamethyl-diethylenetriamine and higher homologues (as described in, for example, DE-A 2,624,527 and 2,624,528), 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether. Triazine compounds, such as, but not limited to, tris(dimethylaminopropyl)hexahydro-1,3,5-triazin can also be used.

In other embodiment, metal catalysts include, such as but not limited to, metal salts and organometallics comprising tin-, titanium-, zirconium-, hafnium, bismuth-, zinc-, aluminium- and iron compounds, such as tin organic compounds, preferably tin alkyls, such as dimethyltin or diethyltin, or tin organic compounds based on aliphatic carboxylic acids, preferably tin diacetate, tin dilaurate, dibutyl tin diacetate, dibutyl tin dilaurate, bismuth compounds, such as bismuth alkyls or related compounds, or iron compounds, preferably iron-(II)-acetylacetonate or metal salts of carboxylic acids, such as tin-II-isooctoate, tin dioctoate, titanium acid esters or bismuth-(III)-neodecanoate or a combination thereof.

The catalysts, as described hereinabove, can be present in amounts up to 20 wt.-%, based on the total weight of the polyurethane resin.

In another embodiment, additives are selected from alkylene carbonates, carbonamides, pyrrolidones, fillers, flame retardants, dyes, pigments, IR absorbing materials, UV stabilizers, plasticizers, antistats, fungistats, bacteriostats, hydrolysis controlling agents, antioxidants, cell regulators and mixtures thereof. Further details regarding additives can be found, for example, in the Szycher's Handbook of Polyurethanes, 2^{nd} edition, 2013. Suitable amounts of these additives are well known to the person skilled in the art. However, for instance, the additives can be present in amounts up to 20 wt.-% based on the total weight of the polyurethane resin.

### Thermoplastic Resin

In one embodiment, the second element (20) in the embodiment 1 is made of a thermoplastic resin. Suitable thermoplastic resins are selected from polyolefin resin, polyamide resin, polyurethane resin, polyester resin and acetal resin.

In an embodiment, the thermoplastic resin is selected from polyolefin resin, polyamide resin, polyurethane resin and acetal resin. In other embodiment, the thermoplastic resin is selected from polyamide resin, polyurethane resin and acetal resin. In still other embodiment, the thermoplastic resin comprises polyamide resin.

In another embodiment, the second element (20) in the embodiment 1 is made of polyamide resin. Suitable polyamide resins have a viscosity number in between 90 ml/g to 350 ml/g. In the present context, the viscosity number is determined from a 0.5 wt.-% solution of the polyamide in 96 wt.-% sulfuric acid at 25° C. according to ISO 307.

In one embodiment, the polyamide resins are, for example, derived from lactams having 7 to 13 ring members or obtained by reaction of dicarboxylic acids with diamines. Examples of polyamides which are derived from lactams include polycaprolactam, polycaprylolactam and/or polylaurolactam.

In another embodiment, suitable polyamide resins further include those obtainable from w-aminoalkyl nitriles, such as but not limited to, aminocapronitrile, which leads to nylon-6. In addition, dinitriles can be reacted with diamine. For example, adiponitrile can be reacted with hexamethylenediamine to obtain nylon-6,6. The polymerization of nitriles is effected in the presence of water and is also known as direct polymerization.

When polyamide resins obtainable from dicarboxylic acids and diamines are used, dicarboxylalkanes (aliphatic dicarboxylic acids) having 6 to 36 carbon atoms, or 6 to 12 carbon atoms, or 6 to 10 carbon atoms can be employed. Aromatic dicarboxylic acids are also suitable. Examples of dicarboxylic acids include adipic acid, azelaic acid, sebacic acid, dodecanedioic acid and also terephthalic acid and/or isophthalic acid.

Suitable diamines include, for example, alkanediamines having 4 to 36 carbon atoms, or 6 to 12 carbon atoms, in particular having 6 to 8 carbon atoms, and aromatic diamines, for example mxylylenediamine, di(4-aminophenyl)methane, di(4-aminocyclohexyl)methane, 2,2-di(4-aminophenyl)propane, 2,2-di(4-aminocyclohexyl)propane and 1,5-diamino-2-methylpentane.

In other embodiment, the polyamide resins include polyhexamethylenedipamide, polyhexamethylenesebacamide and polycaprolactam and also nylon-6/6,6, in particular having a proportion of caprolactam units in between 5 wt.-% to 95 wt.-%.

The non-exhaustive list which follows comprises the aforementioned polyamide resins in the second element (20) in the embodiment 1.

### AB Polymers:

| | |
|---|---|
| PA 4 | Pyrrolidone |
| PA 6 | Ε-caprolactam |
| PA 7 | Enantholactam |
| PA 8 | Caprylolactam |
| PA 9 | 9-aminopelargonic acid |
| PA 11 | 11-aminoundecanoic acid |
| PA 12 | Laurolactam |

### AA/BB Polymers:

| | |
|---|---|
| PA 4.6 | Tetramethylenediamine, adipic acid |
| PA 6.6 | Hexamethylenediamine, adipic acid |
| PA 6.9 | Hexamethylenediamine, azelaic acid |
| PA 6.10 | Hexamethylenediamine, sebacic acid |
| PA 6.12 | Hexamethylenediamine, decanedicarboxylic acid |
| PA 6.13 | Hexamethylenediamine, undecanedicarboxylic acid |
| PA 12.12 | Dodecane-1,12-diamine, decanedicarboxylic acid |
| PA 13.13 | Tridecane-1,13-diamine, undecanedicarboxylic acid |
| PA 6T | Hexamethylenediamine, terephthalic acid |
| PA 9T | Nonyldiamine, terephthalic acid |
| PA MXD6 | m-xylylenediamine, adipic acid |
| PA 6I | Hexamethylenediamine, isophthalic acid |
| PA 6-3-T | Trimethylhexamethylenediamine, terephthalic acid |
| PA 6.6T | (see PA 6 and PA 6T) |
| PA 6.66 | (see PA 6 and PA 6.6) |
| PA 6.12 | (see PA 6 and PA 12) |
| PA 66.6.610 | (see PA 6.6, PA 6 and PA 6.10) |
| PA 6I.6T | (see PA 6I and PA 6T) |
| PA PACM 12 | Diaminocyclohexylmethane, laurolactam |
| PA 6I.6T.PACM | As PA 6I.6T and diaminodicyclohexylmethane |
| PA 12.MACMI | Laurolactam, dimethyldiaminodicyclohexyl- |
| | methane, isophthalic acid |
| PA 12.MACMT | Laurolactam, dimethyldiaminodicyclohexyl- |
| | methane, terephthalic acid |
| PA PDA-T | Phenyldiamine, terephthalic acid |

In one embodiment, the second element (20) in the embodiment 1 is made of polyamide resins selected from polyamide 6, polyamide 11, polyamide 12, polyamide 6.6, polyamide 6.9, polyamide 6.10 and polyamide 6.12. In other embodiment, the polyamide resins are selected from polyamide 6, polyamide 12 and polyamide 6.6.

In yet other embodiment, the polyamide resin comprises polyamide 6. Accordingly, in an embodiment, the second element (20) in the embodiment 1 is made of polyamide 6.

In still other embodiment, the thermoplastic resin further comprises reinforcing fibers. Suitable reinforcing fibers are selected from metal fiber, metalized inorganic fiber, metalized synthetic fiber, glass fiber, carbon fiber, ceramic fiber, mineral fiber, basalt fiber, inorganic fiber, kenaf fiber, jute fiber, flax fiber, hemp fiber, cellulosic fiber, sisal fiber and coir fiber.

In one embodiment, the reinforcing fibers are selected from glass fiber, carbon fiber, ceramic fiber, mineral fiber, basalt fiber, kenaf fiber and jute fiber. In other embodiment, the reinforcing fiber comprises glass fiber.

Accordingly, in an embodiment, the thermoplastic resin in the second element (20) in the embodiment 1 comprises glass fiber.

Similar to the fiber material, the reinforcing fibers can also be subjected to surface treatment agent or sizing. For instance, the reinforcing fibers can be subjected to surface treatment using coupling agents such as, but not limited to, urethane coupling agent and epoxy coupling agent. Any suitable techniques for surface treatment can be used for this purpose. For instance, dip coating and spray coating can be employed.

In one embodiment, the urethane coupling agent comprises at least one urethane group. Suitable urethane coupling agents for use with the reinforcing fibers are known to the person skilled in the art, as for instance described in US pub. no. 2018/0282496. In one embodiment, the urethane coupling agent comprises, for example, a reaction product of an isocyanate, such as but not limited to, m-xylylene diisocyanate (XDI), 4,4′-methylenebis(cyclohexyl isocyanate) (HMDI) or isophorone diisocyanate (IPDI), and a polyester based polyol or a polyether based polyol. In another embodiment, the epoxy coupling agent comprises at least one epoxy group. Suitable epoxy coupling agents for use with reinforcing fibers are known to the person skilled in the art, as for instance described in US pub. no. 2015/0247025 incorporated herein by reference. In one embodiment, the epoxy coupling agent is selected from aliphatic epoxy coupling agent, aromatic epoxy coupling agent or mixture thereof. Non-limiting example of aliphatic coupling agent includes a polyether polyepoxy compound having two or more epoxy groups in a molecule and/or polyol polyepoxy compound having two or more epoxy groups in a molecule. As aromatic coupling agent, a bisphenol A epoxy compound or a bisphenol F epoxy compound can be used.

Suitable amounts of these coupling agents, as described herein, are well known to the person skilled in the art. However, in one embodiment, the coupling agent can be present in an amount of 0.1 parts by mass to 10.0 parts by mass relative to 100 parts by mass of the reinforcing fibers.

Suitable amounts of reinforcing fibers are well known to the person skilled in the art. However, in one embodiment, the reinforcing fiber can be present in an amount in between 10 wt.-% to 90 wt.-% based on the total weight of the thermoplastic resin. In another embodiment, the reinforcing fiber is present in an amount in between 10 wt.-% to 80 wt.-%, or 10 wt.-% to 90 wt.-%, or 70 wt.-% to 60 wt.-%. In another embodiment, it is present in between 20 wt.-% to 60 wt.-%, or 20 wt.-% to 50 wt.-%, or 20 wt.-% to 40 wt.-%.

### Method

In one embodiment, the method in the embodiment 1 comprises in step (A) pultruding the fiber reinforced polyurethane in the die to obtain the first element (10), said die comprising the plurality of first surface features.

Although, pultrusion is well known to the person skilled in the art, typical steps include, such as but not limited to:
(P1) pulling fiber material through an impregnation die,
(P2) supplying the isocyanate and the compound reactive towards isocyanate along with catalysts and/or additives to obtain a reaction mixture and feeding the reaction mixture to the impregnation die,
(P3) contacting the fiber material with the reaction mixture in the impregnation die for a time period and at a temperature sufficient for polymerization of the reaction mixture within the impregnation die to obtain the fiber reinforced polyurethane,
(P4) directing the fiber reinforced polyurethane through the die comprising plurality of first surface features to obtain the first element (10).

In another embodiment, a commercially available polyurethane resin can also be employed. In that case, the fiber reinforced polyurethane will be directly obtained and the step (P2) can be omitted. Such alternative arrangements are well known to the person skilled in the art and therefore, the present invention is not limited by the same.

In an embodiment, the impregnation die in the step (P1) and the die in the step (P4) are structurally different. In other embodiment, the impregnation die in the step (P1) and the die in the step (P4) are same. In yet other embodiment, the die in step (P4) and the die in step (A) of the embodiment 1 are same. Suitable materials for constructing the impregnation die of step (P1) and the die of step (P4) are well known to the person skilled in the art.

In one embodiment, the impregnation die must provide for adequate mixing of the reaction mixture and adequate impregnation of the fiber material. The impregnation die can be fitted with a mixing apparatus, such as a static mixer, which provides for mixing of the reaction mixture before impregnating with the fiber material. Other types of optional mixing devices, such as but not limited to, high pressure impingement mixing device or low-pressure impingement device or low pressure dynamic mixers such as rotating paddles can also be used. In other embodiment, adequate mixing is provided in the impregnation die itself, without any additional mixing apparatus.

Internal mold release additives can be used in pultrusion of the reaction mixture of step (P2). The internal mold release additives prevent sticking or build up in the impregnation die. Suitable internal mold release agents include, such as but not limited to, fatty amides such as erucamide or stearamide, fatty acids such as oleic acid, oleic acid amides, fatty esters such as butyl stearate, octyl stearate, ethylene glycol monostearate, ethylene glycol distearate, glycerine di-oleate, glycerine tri-oleate, and esters of polycarboxylic acids with long chain aliphatic monovalent alcohols, such as dioctyl sebacate, fatty acid metal carboxylates such as zinc stearate and calcium stearate, waxes such as montan wax, chlorinated waxes, fluorine containing compounds such as polytetratfluoroethylene, fatty alkyl phosphates (both acidic and non-acidic types), chlorinated-alkyl phosphates, hydrocarbon oils and combinations thereof.

Other suitable additives for use in pultrusion include moisture scavengers, such as molecular sieves, defoamers such as polydimethylsiloxanes, coupling agents such as the mono-oxirane or organo-amine functional trialkylsilanes and combinations thereof. Fine particulate fillers, such as clays and fine silicas, are often used as thixotropic additives.

Suitable temperatures of the impregnation die in step (P1) and the die in step (P4) are well known to the person skilled in the art. However, in one embodiment, the temperature of the die in step (P4) is higher than the temperature of the impregnation die in step (P1).

In other embodiment, the pultrusion can be carried out in a pultrusion apparatus. Said pultrusion apparatus may optionally comprise a plurality of curing zones. In the present context, “curing zone” refers to the zone comprising the die of step (P4) or step (A) in the embodiment 1.

In one embodiment, the pultrusion apparatus has more than one curing zones, for instance, 2, 3, 4, 5, or 6 curing zones. Different curing zones may be set at different temperatures, if desired, but all the curing zones should have temperature higher than that of the impregnation die in step (P1). In other embodiment, the pultrusion apparatus may contain more than one impregnation die. In yet other embodiment, the pultrusion apparatus has one impregnation die, which is located prior to the first curing zone. The impregnation die is set at a temperature that provides for polymerisation in the reaction mixture before the fiber material is impregnated. The present invention is not limited by the pultrusion apparatus. Such apparatus are well known to the person skilled in the art, for instance, as described in WO 2000/029459.

It is within the broader scope of the invention to obtain reaction mixtures from more than two-components. By “two-component” it is primarily referred to A-side component (isocyanate) stream and B-side component (compound reactive towards isocyanate) stream being fed into the pultrusion apparatus to obtain the reaction mixture. The A-side and B-side components, independent of each other, may further contain catalysts and/or additives in suitable amounts. Said otherwise, the pultrusion in step (A) in the embodiment 1 is also capable of handling two-component system or even a multicomponent system. By “multicomponent system” it is referred to more than two, for instance, three, four, five, six or seven separate component streams. That is, to say, that in addition to the stream comprising the A-side component and the B-side component, there may be present at least one other separate stream comprising isocyanates, compounds reactive towards isocyanate, catalysts and additives, such that the said stream is different from A-side and B-side components.

Suitable mixing ratio between the components in the two-component system or the multicomponent system are well known to the person skilled in the art. For instance, while using the two-component system, the mixing ratio between the isocyanate and the compounds reactive towards isocyanate is in between 1.0:3.0 to 3.0:1.0, or 1.0:2.0 to 2.0:1.0, or even 1.0:1.0.

In one embodiment, suitable temperature range in the step (A) or the plurality of curing zones is in between 80° C. to 250° C.

In other embodiment, the reaction mixture has a gel time at 25° C. of at least 400 seconds. In other embodiment, the gel time at 25° C. is less than 4000 seconds.

In another embodiment, the step (A) of embodiment 1 has the sub-steps defined in steps (P1) to (P4) above. Accordingly, in one embodiment, the temporal sequence of steps in the embodiment 1 becomes step (P1)→step (P2)→step (P3)→step (P4)→step (B).

In another embodiment, the method in the embodiment 1 comprises in step (A) extruding the fiber reinforced polyurethane in the die to obtain the first element (10), said die comprising the plurality of first surface features. The person skilled in the art is well aware of suitable extrusion techniques to obtain the first element (10) in the embodiment 1.

The die in the step (A) comprises a plurality of first surface features. Herein, the phrase “surface feature” refers to the surface characteristics of the elements. The said phrase defines possible physical variations on the surface of the elements, for e.g. the first element (10) and the second element (20) in the present context. In one embodiment, the first surface features are chosen such that minimum or no fiber breakage in the fiber reinforced polyurethane is observed. Suitable surface features include, such as but not limited to, grooves and protrusions. In other embodiment, the plurality of first surface features in the step (A) of the embodiment 1 are plurality of grooves.

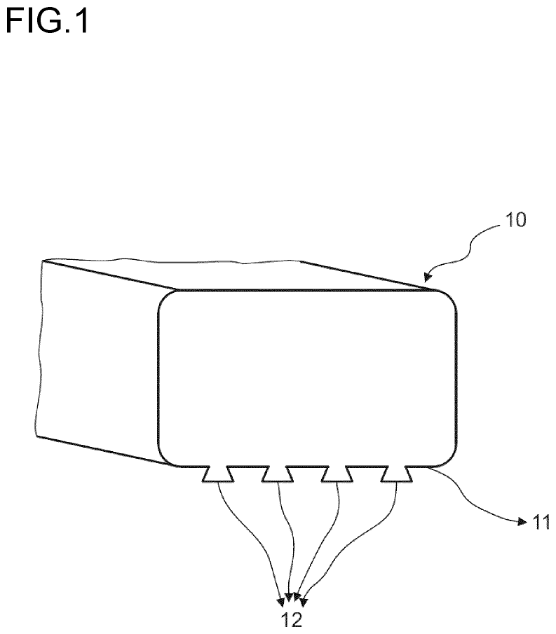

The first element (10) obtained in the step (A) of the embodiment 1 comprises an outer surface (11). The surface characteristics of the first element (10) are defined by the physical variations or surface features of the die. Accordingly, the outer surface (11) comprises the plurality of second surface features (12) formed by the plurality of first surface features in the die, as described herein. In one embodiment, the plurality of first surface features is the plurality of grooves and therefore, the plurality of second surface features (12) is a plurality of male parts obtained therefrom, in the embodiment 1. This is shown in FIG. 1.

In other embodiment, the outer surface (11) comprises the plurality of male parts formed by the plurality of grooves in the die in the embodiment 1.

In yet other embodiment, the plurality of second surface features (12) in the embodiment 1 comprise a first side face (12a), a second side face (12b), and a bottom face (12c). The first side face (12a) and the second side face (12b) are arranged opposite to each other with the bottom face (12c) connecting the said first side face (12a) and the said second side face (12b), thereby forming a second surface feature (12).

In another embodiment, the first side face (12a), the second side face (12b) and the bottom face (12c) is a uniform surface or a non-uniform surface. By “uniform surface”, it is referred to a smooth surface, however, such a surface may be curved or a flat surface. By “non-uniform surface”, it is referred to a rough surface. Said otherwise, the non-uniform surface is not a smooth surface and may have a plurality of surface characteristics, such as but not limited to, serrations, sawtooth, saw-edged, toothed, zigzag, notched and indented.

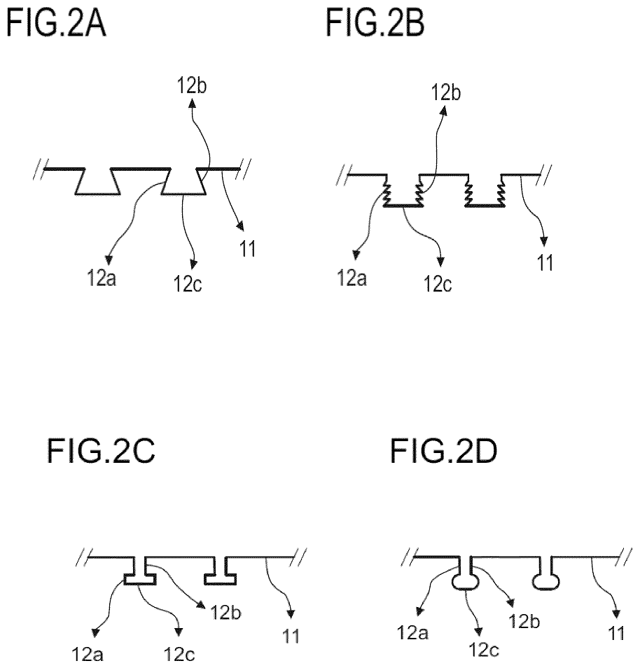

In one embodiment, FIG. 2A illustrates the first embodiment of the second surface feature (12) of the first element (10), wherein the second surface feature (12) is a uniform surface, in particular a dovetail protrusion.

In other embodiment, FIG. 2B illustrates the second embodiment of the second surface feature (12) of the first element (10), wherein the second surface feature (12) is a non-uniform surface, in particular a serrated protrusion.

In another embodiment, FIG. 2C illustrates the third embodiment of the second surface feature (12) of the first element (10), wherein the second surface feature (12) is a uniform surface, in particular a T-shaped protrusion.

In yet another embodiment, FIG. 2D illustrates the fourth embodiment of the second surface feature (12) of the first element (10), wherein the second surface feature (12) is a uniform surface, in particular a bell-shaped protrusion.

In another embodiment, each of the first side face (12a), the second side face (12b) and the bottom face (12c) is the uniform surface, as described herein, and are arranged in a manner to form the dovetail protrusion. Accordingly, in one embodiment, the plurality of second surface features (12) formed by the plurality of first surface features in the embodiment 1 is a plurality of dovetail protrusions formed by the plurality of grooves in the die.

In another embodiment, the second surface features (12) are protrusions that, height wise, extend outwards from the outer surface (11) along a height of the first element (10), width wise, extend from the outer surface (11) along a width of the first element (10), and, length wise, extend from the outer surface (11) and at least partially along a length of the first element (10) in the embodiment 1. In one embodiment, the second surface features (12) can be selected from, such as but not limited to, dovetail protrusions, T-shaped protrusions, serrated protrusions and bell shaped protrusions, as shown in FIGS. 2A-2D.

It is to be understood that the first element (10) can have any suitable geometry, including the conventional continuous cross-section. For instance, it can be a hollow element with a thickness and the second surface features (12), as described herein. The choice of suitable geometry depends on final application of the shaped article (100). The person skilled in the art is well aware of the conventional modifications in the first element (10) to obtain the desired shaped article (100).

In other embodiment, the second surface feature (12) and the third surface feature (22) is selected from a male part, a female part and a combination thereof. In still other embodiment, the second surface feature (12) is the male part and the third surface feature (22) is the female part.

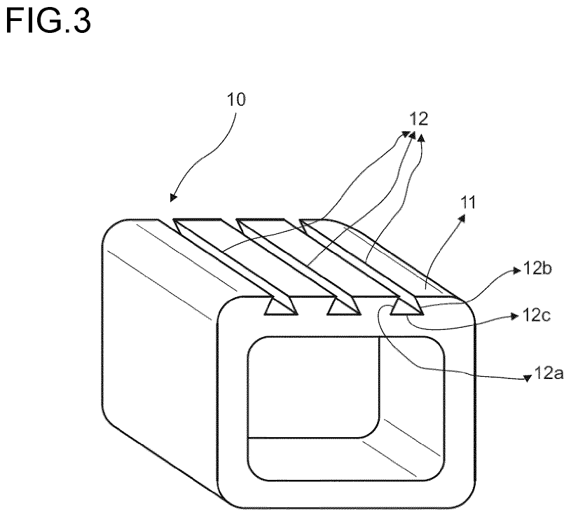

In another embodiment, the second surface feature (12) is the female part and the third surface feature (22) is the male part. This is shown in FIG. 3, wherein the second surface features (12) are recesses that, depth wise, extend inwards in the outer surface (11) along a height of the first element (10), width wise, extend inside the outer surface (11) along a width of the first element (10), and, length wise, extend inside the outer surface (11) and at least partially along a length of the first element (10) in the embodiment 1. In one embodiment, each of the first side face (12a), the second side face (12b) and the bottom face (12c) is the uniform surface and are arranged in a manner to form the dovetail groove.

In another embodiment, the outer surface (21) of the second element (20) in the step (B) in the embodiment 1 comprises a plurality of female parts.

In another embodiment, the second surface feature (12) and the third surface feature (22) can have a mixed surface characteristic. That is, to say, that the outer surface (11, 21) of the first element (10) and/or the second element (20) can have both the male parts as well as the female parts.

In one embodiment, the second element (20) is subjected to injection molding onto the first element (10) to obtain the shaped article (100) in step (B) in the embodiment 1.

In another embodiment, the temperature in the step (B) in the embodiment 1 is in between 270° C. to 300° C.

In other embodiment, the injection molding in the step (B) is injection overmolding in the embodiment 1. Suitable overmolding techniques for the present invention are well known to the person skilled in the art. For instance, overmolding can be performed by arranging a heated injection barrel with a screw shaft arranged inside and linked to a hopped containing the thermoplastic resin in form of granules. The thermoplastic resin is fed into the injection barrel where it is heated and by the action of screw shaft injected in a molten condition through a feed port onto the first element (10). This forms the second element (20) comprising an outer surface (21), said outer surface (21) comprising a plurality of third surface features (22).

In one embodiment, the plurality of third surface features (22) in the embodiment 1 comprise a first side face (22a), a second side face (22b), and a bottom face (22c). The first side face (22a) and the second side face (22b) are arranged opposite to each other with the bottom face (22c) connecting the said first side face (22a) and the said second side face (22b), thereby forming a third surface feature (22). Similar to the second surface feature, the first side face (22a), the second side face (22b) and the bottom face (22c) of the third surface feature (22) is a uniform surface or a non-uniform surface. However, the first side face (22a), the second side face (22b) and the bottom face (22c) of the third surface feature are chosen such that the first element positively locks the second element. That is, to say, that the second surface features (12) completely overlap with each of the third surface features (22).

In another embodiment, the third surface features (22) are recesses that, depth wise, extend inwards in the outer surface (21) along a height of the second element (20), width wise, extend inside the outer surface (21) along a width of the second element (20), and, length wise, extend inside the outer surface (21) and at least partially along a length of the second element (20) in the embodiment 1.

In one embodiment, the second element (20) has the length, width and the height equal to the corresponding length, width and height of the first element (10) in the embodiment 1. In another embodiment, the second element (20) has the length, width and the height different than the length, width and height of the first element (10) in the embodiment 1.

In other embodiment, each of the third surface features (22) in the second element (20) are equal to each of the second surface features (12) in the first element (10) in the embodiment 1.

It is to be further understood that the second element (20) can have any suitable geometry, including the conventional continuous cross-section. For instance, the second element (20) can have various intricate features, such as but not limited to brackets, ribs and bosses. Such features are well known to the person skilled in the art and therefore, the present invention is not limited by the same. The presence of these intricate features further improves the mechanical property of the shaped article (100).

In an embodiment, the surface characteristics on the outer surface (21) of the second element (20) is primarily dependent on the surface characteristics on the outer surface (21) of the first element (10). The outer surface (21) of the second element (20) takes the surface characteristics which complements the surface characteristics of the first element (10). Said otherwise, the surface characteristics of the first element (10) and the second element (20) are such that the first element (10) positively locks the second element (20) to form the shaped article (100). The phrases “positively lock”, “positively interlock” and “positive interlock” can be used interchangeably within the present context. In one embodiment, the positive interlock is formed by each of the second surface features (12) completely overlapping with each of the third surface features (22). That is, to say, that each of the second surface features (12) completely fit into each of the third surface features (22) to form an interlock in the embodiment 1.

The positive interlock formed by the first element (10) and the second element (20) can be determined by peel test. In the peel test, the first element (10) is fitted in an injection mold tool cavity of a pre-determined dimension and subjected to injection overmolding, as described herein. After overmolding, each element is drilled and tapped so that a threaded fastener can be applied to each side to begin pulling the elements apart, while measuring the force and deflection required to separate the elements. Comparison can then be made between different elements, surface treatments and processing conditions to determine the best adhesion.

In one embodiment, no adhesive or fastening means is present between the second element (20) and first element (10) in the embodiment 1, other than the positive lock described herein. By avoiding the adhesives or fastening means, the shaped article (100) is comparatively cheaper than the shaped articles making use of the adhesives or fastening means. Still in the absence of adhesives or fastening means, the shaped article (100) has acceptable mechanical properties or in fact same or even good mechanical properties than the conventional ones. In the present context, fastening means is referred to additional devices or means for securing the second element (20) and the first element (10) in the embodiment 1.

In another embodiment, the second element (20) and the first element (10) in the embodiment 1 further comprise of adhesives or fastening means other than the positive lock. Suitable adhesives or fastening means for this purpose are well known to the person skilled in the art. The presence of adhesives or fastening means, although result in slightly higher costs, further improve the mechanical properties of the shaped article (100).

The thermoplastic resin overmolded on the thermoset pultruded profile to give the shaped article (100) in the embodiment is particularly advantageous as it enhances the joining capabilities of the thermoplastic and thermoset materials, and results in enhanced stiffness. Further, the surface features formed on the pultruded thermoset part result in stronger interlocking when overmolded using the thermoplastic material. This enables the shaped article (100) to have a complex geometry with acceptable or in fact good mechanical properties, is relatively inexpensive to manufacture and optionally require an adhesive or fastening means. Each of the first element (10) and the second element (20) can have different surface characteristics and intricate features, respectively, thereby rendering the shaped article (100) suitable for numerous applications, such as but not limited to, vehicle door intrusion beam, structural inserts in body in white (BIW), bumper beams, instrument panel cross members, seating structural inserts and front end module structure.

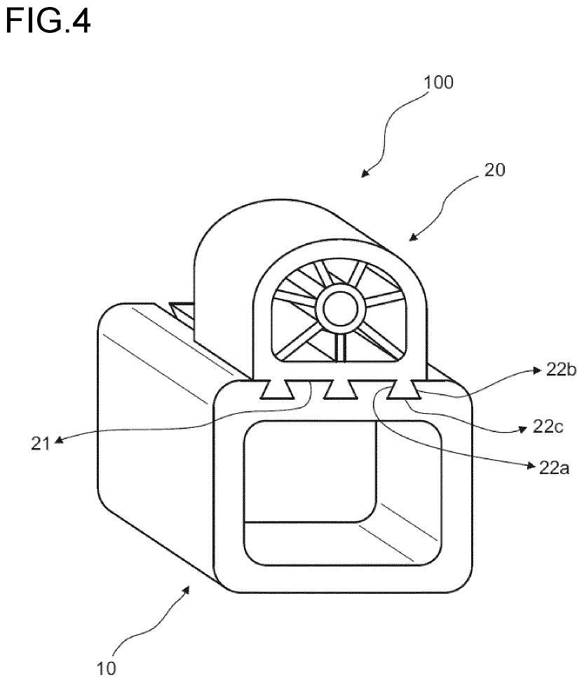

One such shaped article (100) bearing the characteristics, as described hereinabove, is shown in FIG. 4. The shaped article (100) is obtained by the first element (10) positively locking the second element (20) and bearing the complex geometry, which is difficult or in fact not possible in conventional pultrusion and injection molding techniques. Therefore, the present invention provides for a novel and improved method for obtaining the shaped article (100).

Another aspect of the present invention is embodiment 2 which is directed to a shaped article (100) obtained by the process described herein.

Yet another aspect of the present invention is embodiment 3 which is directed to the use of the above shaped article (100) in vehicle door intrusion beam, structural inserts in body in white, bumper beams, instrument panel cross members, seating structural inserts and front end module structure.

List of reference numeral

| | |
|---|---|
| 100 | Shaped article |
| 10 | First element |
| 11 | Outer surface of the first element |
| 12 | Second surface feature |
| 12a | First side face |
| 12b | Second side face |
| 12c | Bottom face |
| 20 | Second element |
| 21 | Outer surface of the second element |
| 22 | Third surface feature |
| 22a | First side face |
| 22b | Second side face |
| 22c | Bottom face |

The present invention is illustrated in more detail by the following embodiments and combinations of embodiments which result from the corresponding dependency references and links:
I. A method for producing a shaped article (100), said method comprising at least the steps of:
   (A) pultruding or extruding a fiber reinforced polyurethane in a die to obtain a first element (10), said die comprising a plurality of first surface features,
      wherein the first element (10) comprises an outer surface (11), said outer surface (11) comprising a plurality of second surface features (12) formed by the plurality of first surface features in the die,
   (B) injection molding a second element (20) onto the first element (10) to obtain the shaped article (100), wherein the second element (20) comprises an outer surface (21), said outer surface (21) comprising a plurality of third surface features (22),
      wherein the first element (10) positively locks the second element (20) such that each of the second surface features (12) completely overlap with each of the third surface features (22).
II. The method according to embodiment I, wherein the second surface feature (12) and the third surface feature (22) is selected from a male part, a female part and a combination thereof.
III. The method according to embodiment I or II, wherein the fiber reinforced polyurethane comprises a fiber material and a polyurethane resin.
IV. The method according to embodiment III, wherein the fiber material has an area weight in between 100 g/m² to 1500 g/m².
V. The method according to embodiment III or IV, wherein the fiber material is selected from metal fiber, metalized inorganic fiber, metalized synthetic fiber, glass fiber, polyester fiber, polyamide fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.
VI. The method according to one or more of embodiments III to V, wherein the fiber material is selected from glass fiber, carbon fiber, polyester fiber, polyamide fiber, aramid fiber and basalt fiber.
VII. The method according to one or more of embodiments III to VI, wherein the polyurethane resin is obtained by reacting:
   (a) an isocyanate, and
   (b) a compound reactive towards isocyanate.
VIII. The method according to embodiment VII, wherein the isocyanate comprises an aliphatic isocyanate or an aromatic isocyanate.
IX. The method according to embodiment VIII, wherein the aliphatic isocyanate is selected from tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocyanatomethylcyclohexane isocyanates, isocyanatoethylcyclohexane isocyanates, bis(isocyanatomethyl)-cyclohexane diisocyanates, 4,4′-di isocyanatodicyclohexylmethane, pentamethylene 1,5-diisocyanate, isophorone diisocyanate and mixtures thereof.
X. The method according to embodiment VIII, wherein the aromatic isocyanate is selected from toluene diisocyanate; polymeric toluene diisocyanate, methylene diphenyl diisocyanate; polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropyl phenylene-2,4-di isocyanate; 1-methyl-3,5-diethyl phenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxyphenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate, 1,3,5-triisopropyl benzene-2,4,6-triisocyanate, carbodiimide-modified isocyanates, urethane-modified isocyanates, allophanate-modified isocyanates, isocyanurate-modified isocyanates, urea-modified isocyanates and biuret-containing isocyanates, and mixtures thereof.
XI. The method according to one or more of embodiments VII to X, wherein the compound reactive towards isocyanate comprises a polyol and optionally a chain extender.
XII. The method according to embodiment XI, wherein the polyol has an average functionality in between 2.0 to 8.0 and a hydroxyl number in between 15 mg KOH/g to 1800 mg KOH/g.
XIII. The method according to embodiment XI or XII, wherein the polyol is selected from polyether polyol, polyester polyol, polyether-ester polyol or a mixture thereof.
XIV. The method according to one or more of embodiments XI to XIII, wherein the chain extender has a molecular weight in between 49 g/mol to 399 g/mol.
XV. The method according to one or more of embodiments III to XIV, wherein the polyurethane resin is obtained in the presence of catalysts and/or additives.
XVI. The method according to embodiment XV, wherein the additives are selected from alkylene carbonates, carbonamides, pyrrolidones, fillers, flame retardants, dyes, pigments, IR absorbing materials, UV stabilizers, plasticizers, antistats, fungistats, bacteriostats, hydrolysis controlling agents, antioxidants, cell regulators and mixtures thereof.
XVII. The method according to one or more of embodiments I to XVI, wherein in step (A) the plurality of second surface features (12) comprise a first side face (12a), a second side face (12b) and a bottom face (12c).
XVIII. The method according to embodiment XVII, wherein the first side face (12a) and the second side face (12b) are arranged opposite to each other with the bottom face (12c) connecting the said first side face (12a) and the said second side face (12b), thereby forming a first surface feature.
XIX. The method according to embodiment XVIII, wherein the first side face (12a), the second side face (12b) and the bottom face (12c) is a uniform surface or a non-uniform surface.
XX. The method according to one or more of embodiments XVII to XIX, wherein each of the first side face (12a), the second side face (12b) and the bottom face (12c) is a uniform surface arranged in a manner to form a dovetail protrusion.
XXI. The method according to one or more of embodiments I to XX, wherein each of the second surface features (12) on the outer surface (11) of the first element (10) are equal to each of the first surface features in the die.
XXII. The method according to one or more of embodiments I to XXI, wherein each of the second surface features (12) on the outer surface (11) of the first element (10) has a height equal to a depth of each of the first surface features in the die.
XXIII. The method according to one or more of embodiments I to XXII, wherein the injection molding in step (B) is injection overmolding.
XXIV. The method according to one or more of embodiments I to XXIII, wherein the second surface features (12) are protrusions that, height wise, extend outwards from the outer surface (11) along a height of the first element (10), width wise, extend from the outer surface (11) along a width of the first element (10), and, length wise, extend from the outer surface (11) and at least partially along a length of the first element (10).
XXV. The method according to one or more of embodiments I to XXIV, wherein the temperature in the step (B) is in between 270° C. to 300° C.
XXVI. The method according to one or more of embodiments I to XXV, wherein the second element (20) is made of a thermoplastic resin.
XXVII. The method according to embodiment XXVI, wherein the thermoplastic resin is selected from polyolefin resin, polyamide resin, polyurethane resin, polyester resin and acetal resins.
XXVIII. The method according to embodiment XXVI or XXVII, wherein the thermoplastic resin comprises polyamide resin.
XXIX. The method according to embodiment XXVII or XXVIII, wherein the polyamide resin is selected from polyamide 6, polyamide 11, polyamide 12, polyamide 6.6, polyamide 6.9, polyamide 6.10 and polyamide 6.12.
XXX. The method according to one or more of embodiments XXVII to XXIX, wherein the polyamide resin is selected from polyamide 6, polyamide 12 and polyamide 6.6.
XXXI. The method according to one or more of embodiments XXVII to XXX, wherein the polyamide resin comprises polyamide 6.
XXXII. The method according to one or more of embodiments XXVI to XXXI, wherein the thermoplastic resin further comprises reinforcing fibers.
XXXIII. The method according to embodiment XXXII, wherein the reinforcing fibers are selected from metal fiber, metalized inorganic fiber, metalized synthetic fiber, glass fiber, carbon fiber, ceramic fiber, mineral fiber, basalt fiber, inorganic fiber, kenaf fiber, jute fiber, flax fiber, hemp fiber, cellulosic fiber, sisal fiber and coir fiber.
XXXIV. The method according to embodiment XXXII or XXXIII, wherein the reinforcing fibers are selected from glass fiber, carbon fiber, ceramic fiber, mineral fiber, basalt fiber, kenaf fiber and jute fiber.
XXXV. The method according to one or more of embodiments XXXII to XXXIV, wherein the reinforcing fiber comprises glass fiber.
XXXVI. The method according to one or more of embodiments XXXII to XXXV, wherein the reinforcing fibers are subjected to a surface treatment agent.
XXXVII. The method according to embodiment XXXVI, wherein the surface treatment agent is a coupling agent selected from a silane coupling agent, titanium coupling agent, aluminate coupling agent, urethane coupling agent and epoxy coupling agent.
XXXVIII. The method according to one or more of embodiments XXXII to XXXVII, wherein the amount of the reinforcing fibers is in between 10 wt.-% to 50 wt.-% based on the total weight of a mixture comprising thermoplastic resin and reinforcing fibers.
XXXIX. The method according to one or more of embodiments I to XXXVIII, wherein the third surface features (22) are recesses that, depth wise, extend inwards in the outer surface (21) along a height of the second element (20), width wise, extend inside the outer surface (21) along a width of the second element (20), and, length wise, extend inside the outer surface (21) and at least partially along a length of the second element (20).
XL. The method according to one or more of embodiments I to XXXIX, wherein the second element (20) has the length, width and height equal to the corresponding length, width and height of the first element (10).
XLI. The method according to one or more of embodiments I to XL, wherein each of the third surface features (22) in the second element (20) are equal to each of the second surface features (12) in the first element (10).
XLII. The method according to one or more of embodiments I to XLI, wherein the positive interlock is formed by each of the second surface features (12) completely overlapping with each of the third surface features (22).
XLIII. The method according to one or more of embodiments I to XLII, wherein no adhesive or fastening means other than the positive lock is present between the second element (20) and the first element (10).
XLIV. A shaped article (100) obtained by the method according to one or more of embodiments I to XLIII.
XLV. Use of the shaped article (100) according to embodiment XLIV or as obtained by the method according to one or more of embodiments I to XLIII in vehicle door intrusion beam, structural inserts in BIW, bumper beams, instrument panel cross members, seating structural inserts, front end modules structures.

### Examples

The presently claimed invention is illustrated by the non-restrictive examples which are as follows:

Compounds
Fiber reinforced polyurethane

| | |
|---|---|
| Fiber material | Continuous rovings of glass fiber with average |
| | fiber diameter ranging between 17 μm to 34 |
| | μm and silane sizing was obtained from |
| | Nippon Electric Glass |
| Polyurethane resin | Difunctional and trifunctional polyether polyol |
| | having hydroxyl number in between 50 mg |
| | KOH/g to 400 mg KOH/g, and |
| | Carbodiimide modified MDI (4,4′ and 2,4′ |
| | isomers of MDI) having NCO content in |
| | between 29.2% and 29.5%, obtained from |
| | BASF |

Thermoplastic resin

| | |
|---|---|
| Polyamide resin | 30 wt.-% glass fiber reinforced polyamide 6 |
| | obtained from BASF |

Standard methods

| | |
|---|---|
| Tensile strength | ASTM D638 |

Flat pultruded samples were produced and machined with the dovetail geometry (4 mm wide×3 mm depth) using a mill. These samples were overmolded with the polyamide resin and subjected to peel test. The results are summarized in Tables 1 and 2 below.

### Peel Test

Fiber reinforced polyurethane resin, as flat pultruded sample, was fitted in an injection mold tool cavity of 5 inch (length)×0.5 inch (width)×2 mm (thickness) to be overmolded with a 2 mm thick layer of the polyamide resin. After overmolding, each material was drilled and tapped so that a threaded fastener can be applied to each side to begin pulling the materials apart, while measuring the force and deflection required to separate the materials. Comparisons were then made between different materials, surface treatments and processing conditions to determine the best adhesion.

TABLE 1
Peel test results for samples without dovetail based positive interlocking
Peel test without dovetail

| Sample no. | Peak load (in N) |
|---|---|
| 1 | 3.56 |
| 2 | 8.01 |
| 3 | 6.675 |
| 4 | 88.555 |
| 5 | 25.365 |
| 6 | 220.72 |
| 7 | 67.195 |
| 8 | 20.025 |
| 9 | 3.115 |
| 10 | 3.56 |

TABLE 2
Peel test results for samples with dovetail based positive interlocking
Peel test with dovetail

| Sample no. | Peak load (in N) |
|---|---|
| 1 | 226.95 |
| 2 | 307.05 |
| 3 | 801 |
| 4 | 854.4 |
| 5 | 947.85 |
| 6 | 253.65 |
| 7 | 805.45 |
| 8 | 1041.3 |
| 9 | 872.2 |
| 10 | 792.1 |

As evident in Tables 1 and 2, the peak load for samples with dovetail are substantially higher than those without dovetail. For a particular sample, the peak load for dovetail based positive interlocking is manifold higher than the corresponding sample without dovetail.

1.-11. (canceled)

12. A method for producing a shaped article (100), said method comprising at least the steps of:
(A) pultruding or extruding a fiber reinforced polyurethane in a die to obtain a first element (10), said die comprising a plurality of first surface features,
wherein the first element (10) comprises an outer surface (11), said outer surface (11) comprising a plurality of second surface features (12) formed by the plurality of first surface features in the die,
(B) injection molding a second element (20) onto the first element (10) to obtain the shaped article (100), wherein the second element (20) comprises an outer surface (21), said outer surface (21) comprising a plurality of third surface features (22),
wherein the first element (10) positively locks the second element (20) such that each of the second surface features (12) completely overlap with each of the third surface features (22).

13. The method according to claim 12, wherein the second surface feature (12) and the third surface feature (22) is selected from a male part, a female part and a combination thereof.

14. The method according to claim 13, wherein each of the second surface features (12) on the outer surface (11) of the first element (10) has a height equal to a depth of each of the first surface features in the die.

15. The method according to claim 14, wherein the second surface features (12) are protrusions that, height wise, extend outwards from the outer surface (11) along a height of the first element (10), width wise, extend from the outer surface (11) along a width of the first element (10), and, length wise, extend from the outer surface (11) and at least partially along a length of the first element (10).

16. The method according to claim 15, wherein the second element (20) is made of a thermoplastic resin.

17. The method according to claim 16, wherein the thermoplastic resin is selected from polyolefin resin, polyamide resin, polyurethane resin, polyester resin and acetal resins.

18. The method according to claim 17, wherein the third surface features (22) are recesses that, depth wise, extend inwards in the outer surface (21) along a height of the second element (20), width wise, extend inside the outer surface (21) along a width of the second element (20), and, length wise, extend inside the outer surface (21) and at least partially along a length of the second element (20).

19. The method according to claim 18, wherein the second element (20) has the length, width and height equal to the corresponding length, width and height of the first element (10).

20. The method according to claim 19, wherein no adhesive or fastening means other than the positive lock is present between the second element (20) and the first element (10).

21. A shaped article (100) obtained by a method of producing a shaped article (100), said method comprising at least the steps of:
(C) pultruding or extruding a fiber reinforced polyurethane in a die to obtain a first element (10), said die comprising a plurality of first surface features,
wherein the first element (10) comprises an outer surface (11), said outer surface (11) comprising a plurality of second surface features (12) formed by the plurality of first surface features in the die,
(D) injection molding a second element (20) onto the first element (10) to obtain the shaped article (100), wherein the second element (20) comprises an outer surface (21), said outer surface (21) comprising a plurality of third surface features (22),
wherein the first element (10) positively locks the second element (20) such that each of the second surface features (12) completely overlap with each of the third surface features (22).

22. The shaped article (100) according to claim 21, wherein the second surface feature (12) and the third surface feature (22) is selected from a male part, a female part and a combination thereof.

23. The shaped article (100) according to claim 22, wherein each of the second surface features (12) on the outer surface (11) of the first element (10) has a height equal to a depth of each of the first surface features in the die.

24. The shaped article (100) according to claim 23, wherein the second surface features (12) are protrusions that, height wise, extend outwards from the outer surface (11) along a height of the first element (10), width wise, extend from the outer surface (11) along a width of the first element (10), and, length wise, extend from the outer surface (11) and at least partially along a length of the first element (10).

25. The shaped article (100) according to claim 24, wherein the second element (20) is made of a thermoplastic resin.

26. The shaped article (100) according to claim 25, wherein the thermoplastic resin is selected from polyolefin resin, polyamide resin, polyurethane resin, polyester resin and acetal resins.

27. The shaped article (100) according to claim 26, wherein the third surface features (22) are recesses that, depth wise, extend inwards in the outer surface (21) along a height of the second element (20), width wise, extend inside the outer surface (21) along a width of the second element (20), and, length wise, extend inside the outer surface (21) and at least partially along a length of the second element (20).

28. The shaped article (100) according to claim 27, wherein the second element (20) has the length, width and height equal to the corresponding length, width and height of the first element (10).

29. The shaped article (100) according to claim 28, wherein no adhesive or fastening means other than the positive lock is present between the second element (20) and the first element (10).

30. Use of the shaped article (100) according to claim 12, in vehicle door intrusion beam, structural inserts in body in white, bumper beams, instrument panel cross members, seating structural inserts and front end modules structures.

31. Use of the shaped article (100) according to claim 20, in vehicle door intrusion beam, structural inserts in body in white, bumper beams, instrument panel cross members, seating structural inserts and front end modules structures.
